(19) United States
(12) Patent Application Publication
(10) Pub. No.: US 2010/0166818 A1
(43) Pub. Date: Jul. 1, 2010

(54) Laundry additive for the treatment and prevention of bed bugs

(76) Inventor: Stevan L. Troutman, Virginia Beach, VA (US)

Correspondence Address: LEIGH P. GREGORY, PO BOX 168, CLEMSON, SC, 29633-0168, US

(21) Appl. No.: 12/590,961

(22) Filed: Nov. 17, 2009

Related U.S. Application Data
(60) Provisional application No. 61/199,463, filed on Nov. 17, 2008.

(51) Int. Cl. A01N 25/34; A01N 59/16; A01N 31/14; A01N 37/34; A01N 43/30; A01P 1/00

(52) U.S. Cl. 424/411; 424/646; 514/721; 514/521; 514/464

(57) ABSTRACT

A laundry additive such as a fabric dryer sheet formed of a flexible substrate contains an insecticidally effective amount of an insecticide, preferably a pyrethrum, in an amount between about 0.05 and about 10 grams per square foot. Alternatively, the insecticide may be included as a component in a rinse-cycle laundry additive. Such laundry additives are appropriate for use by institutions such as hotels, cruise ships, and nursing homes, hospitals, and shelters in the prevention and control of bed bugs.

The present application claims the benefit of prior provisional patent application, U.S. Ser. No. 61/199,463, filed Nov. 17, 2009.

### FIELD OF THE INVENTION

The present invention is directed to a laundry additive for the rinse cycle and for the dryer for the prevention and extermination of a variety of pests, specifically bed bugs.

### BACKGROUND OF THE INVENTION

Bed bugs are increasingly becoming a problem within residences of all kinds, including homes, apartments, hotels, cruise ships, dormitories and shelters. Small wingless insects that feed solely upon the blood of warm-blooded animals, bed bugs and their relatives have evolved as nest parasites. Certain kinds inhabit bird nests and bat roosts and await the return of their hosts; others have adapted well to living in the ‘nests’ (homes) of people.

Bed bugs and their relatives occur nearly worldwide. They became relatively scarce during the latter part of the 20^{th} century, but their populations have resurged in recent years, particularly throughout parts of North America, Europe, and Australia. They are most abundant in rooms where people sleep, and they generally hide nearest the bed or other furniture used for sleeping. Bed bugs are most active in the middle of the night, but when hungry, they will venture out during the day to seek a host. Their flattened bodies allow them to conceal themselves in cracks and crevices around the room and within furniture. Favored hiding sites include the bed frame, mattress and box spring. Clutter around the room offers additional sites for these bugs to hide, and increases the difficulty in eliminating bed bugs once they have become established. While an annoyance for individuals in private residences, the recent increase in the bed bug population represents a serious concern for the hotel and cruise ship industries.

Currently, efforts to control this problem have included replacing carpet with solid surface floorings such as tile, favoring a minimalistic design free of excess drapes, upholstery and other textiles, encasing mattresses in impervious textiles or films, and spraying freshly applied sheets with an insecticide known to kill bed bugs or control their population. However, the problem continues and further efforts are needed.

In some parts of the world even more serious pest-related threats abound. Malaria, spread by mosquitoes and other insects, is a threat to more than 40% of the world's population. In the more than 100 countries where malaria is epidemic it is common to dip textiles such as blankets and nets in insecticides of a sufficient concentration to withstand extended wear and washings. U.S. Publication 2007/0009563 A1 is directed to a process for coating fibers or fabrics with insecticide which requires dipping the fabric in a specific insecticide mixture and which provides reasonably effective mosquito control for as many as many as 20 washings.

Further, hospital laundries have long dealt with controlling the spread of disease by pathogenic organisms found on linens and towels. U.S. Pat. No. 5,154,947 is directed to a method for applying a microbicidal additive during the laundry drying cycle.

However, while development continues in addressing the spread of diseases both in hospitals and developing countries, neither of these problems have led to solutions for commercial and non-commercial institutions struggling with the prevention and control of bed bugs.

### SUMMARY OF THE INVENTION

Accordingly, the present invention is directed to a fabric dryer sheet which includes a flexible substrate and an insecticidally effective amount of an insecticide, preferably a pyrethrum, optionally a diatomaceous earth, the flexible substrate containing between about 0.05 and about 10 grams per square foot of the insecticide. Preferably, the insecticide is a pyrethrum and the pyrethrum is selected from natural pyrethrins, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof. It is also preferred that the flexible substrate further contains at least one further additive such as perfumes, fabric softeners, starches and anti-static agents. Optionally, the flexible substrate also may contain an insect growth regulator.

Further, the present invention is directed to a rinse added fabric treating composition which is a solution including an insecticidally effective amount of an insecticide, preferably a pyrethrum, optionally a diatomaceous earth, wherein the solution contains from about 0.5 to about 10 percent by weight of the insecticide. Preferably, the pyrethrum is selected from natural pyrethrins, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof. It is also preferred that the solution further contains at least one further additive such as perfumes, fabric softeners, starches and anti-static agents. Optionally, the solution may further contain an insect growth regulator.

### DETAILED DESCRIPTION OF PREFERRED EMBODIMENTS

The present invention is directed to laundry additives which are useful in controlling and preventing infestations of pests such as bed bugs, although other pests also may be controlled to a certain degree with the present compositions. Exemplary of such pests are fleas, head lice, dust mites, mosquitoes, moths, roaches, ants and a variety of other crawling and flying insects. Specifically, the present invention addresses the needs of hotels, cruise ships, shelters, and other institutions, which must regularly change bed linens for an ever changing population of residents, some of whom may unwittingly bring bed bugs to their temporary bed. The present laundry additives may be used regularly by such institutions as an important part of their efforts to control and prevent infestations.

In a preferred embodiment the present invention is directed to a fabric dryer sheet which includes a flexible substrate and an insecticidally effective amount of an insecticide, most preferably a pyrethrum, optionally a diatomaceous earth. The substrate may be of any material commonly used for such purpose. Representative articles are those that are adapted to be employed in an automatic laundry dryer, of the types disclosed in U.S. Pat. No. 3,989,631 Marsan, issued Nov. 2, 1976; U.S. Pat. No. 4,055,248, Marsan, issued Oct. 25, 1977; U.S. Pat. No. 4,073,996. Bedenk et al., issued Feb. 14, 1978; U.S. Pat. No. 4,022,938, Zaki et al., issued May 10, 1977; U.S. Pat. No. 4,764,289, Trinh. issued Aug. 16, 1988; U.S. Pat. No. 4,808,086, Evans et al., issued Feb. 28, 1989; U.S. Pat. No. 4,103,047, Zaki et al., issued Jul. 25, 1978; U.S. Pat. No. 3,736,668, Dillarstone, issued Jun. 5, 1973; U.S. Pat. No. 3,701,202, Compa et al., issued Oct. 31, 1972; U.S. Pat. No. 3,634,947, Furgal, issued Jan. 18, 1972; U.S. Pat. No. 3,633,538, Hoeflin, issued Jan. 11, 1972; and U.S. Pat. No. 3,435,537, Rumsey, issued Apr. 1, 1969; and U.S. Pat. No. 4,000,340, Murphy et al., issued Dec. 28, 1976, all of said patents being incorporated herein by reference.

Preferably, the present fabric dryer sheet is provided as an article of manufacture which effectively releases the impregnated insecticide in an automatic laundry (clothes) dryer. The dryer sheet can be designed for single usage or for multiple uses, although sheets for single usage are preferred. Optionally, the flexible substrate can release the insecticide and then itself be dispersed and/or exhausted from the dryer. Other embodiments of the flexible substrate include synthetic foams, towel-like substrates, particles (tablets, pellets, granules, etc) and dispensers affixed to the dryer wall.

Regardless of the form it takes, the flexible substrate has impregnated therein an insecticidally effective amount of an insecticide. Generally, the substrate contains between about 0.05 and about 10 grams per square foot of the insecticide. Thus, the substrate may contain at least about 1 gram, at least about 3 grams, and at least about 5 grams per square foot of the insecticide. Further, although the substrate preferably contains no more than about 10 grams per square foot of the insecticide, in less preferred embodiments it contains no more than about 20 grams, no more than about 30 grams, no more than 40 grams, or no more than 50 grams per square foot of the insecticide. Any amount which provides an insecticidally effective amount may be present.

Preferably, the insecticide contained on the present flexible substrate is of the type which kills the target insect on contact. Therefore, it is more preferred that the insecticide is a pyrethrum. Pyrethrins are natural insecticides produced by certain species of the chrysanthemum plant. The flowers of the plant are harvested shortly after blooming and are either dried and powdered or the oils within the flowers are extracted with solvents. The resulting pyrethrin containing dusts and extracts usually have an active ingredient content of about 30%. These active insecticidal components are collectively known as pyrethrins. Two pyrethrins are most prominent, pyrethrin-I and pyrethrin-II. The pyrethrins have another four different active ingredients, Cinerin I and II and Jasmolin I and II. Pyrethrin compounds have been used primarily to control human lice, mosquitoes, cockroaches, beetles and flies.

The natural pyrethrins are contact poisons which quickly penetrate the nerve system of the insect. A few minutes after application, the insect cannot move or fly away. But, a “knockdown dose” does not mean a killing dose. The natural pyrethrins are swiftly detoxified by enzymes in the insect. Thus, some pests will recover. To delay the enzyme action so a lethal dose is assured, organophosphates, carbamates, or synergists often are added to the pyrethrins.

Semisynthetic derivatives of the chrysanthemumic acids have been developed as insecticides. These are called pyrethroids and tend to be more effective than natural pyrethrins while they are less toxic to mammals. One common synthetic pyrethroid is allethrin.

For purposes of the present patent application, the term “pyrethrins” refers to the natural insecticides derived from chrysanthemum flowers; “pyrethroids” are the synthetic chemicals, and “pyrethrum” is a general name covering both compounds.

In accordance with the present invention the insecticide is preferably a pyrethrum and the pyrethrum is selected from pyrethrins, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof.

An alternative insecticide is diatomaceous earth, which physically rather than chemically kills the bed bugs. Diatomaceous earth is the fossilized remains of microscopic shells and a known desiccant. Thus, diatomaceous earth kills bed bugs by dehydration. Diatomaceous earth may be the sole insecticide or provided in combination with the pyrethrum.

It is preferred that the flexible substrate further contains at least one further additive such as perfumes, fabric softeners, starches and anti-static agents. Optionally, the flexible substrate also may contain an insect growth regulator. Rather than killing the target insect, insect growth regulators interrupt or inhibit the life cycle of the pest. The insects are rendered incapable of reproducing because they are not allowed to reach full maturity. In addition to neutering the bed bugs, the correct insect growth regulator can prevent them from biting. Thus, while not directly killing the pests, insect growth regulators are important components of any plan for controlling an insect infestation and are useful additives for the present laundry composition.

Other potential additives include Piperonyl Butoxide and n-Octyl Bicycloheptene Dicarboximide, both of which are pesticide synergists. Neither by itself has pesticidal properties. However, when added to insecticide mixtures, typically pyrethrums or carbamates, the primary insecticide's potency is increased considerably.

In another embodiment, the present invention is directed to a rinse added fabric treating composition which is a solution including an insecticidally effective amount of an insecticide, most preferably a pyrethrum but optionally diatomaceous earth. In effectively treating bed bugs, the solution preferably contains from about 0.5 to about 10 percent by weight of the insecticide. Thus, the solution may include at least about 1 percent, at least about 3 percent, at least about 5 percent by weight of the insecticide. While in a preferred embodiment the solution contains no more than about 10 percent by weight of the insecticide, it is also within the scope of the present invention that the solution may contain at least about 15 percent, at least about 20 percent, at least about 25 percent, at least about 30 percent, at least about 35 percent, at least about 40 percent at least about 45 percent and at least about 50 percent by weight of the insecticide. Any amount which represents an insecticidally effective amount may be provided. Preferably, the insecticide is a pyrethrum and the pyrethrum is selected from pyrethrins, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof. However, as with the dryer sheet embodiment discussed above, it is also within the scope of the present invention that diatomaceous earth is present, either alone or in combination with the pyrethrum, as an insecticide. It is also preferred that the solution further contains at least one further additive such as perfumes, fabric softeners, starches and anti-static agents. Optionally, the solution may further contain an insect growth regulator.

In addition to the present laundry additives, it has been found in accordance with the present invention that the pyrethrums and insect growth regulators described herein may be beneficially included in solutions used to shampoo or steam clean other textiles such as carpeting, upholstery and drapes where bed bugs may hide. Furthermore, managers of institutions providing sleeping quarters to a constantly changing population may benefit from applying a coating, such as a polyurethane coating, containing such insecticides to wooden and metal furniture in the sleeping vicinity.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims. Moreover, Applicant hereby discloses all subranges of all ranges disclosed herein. These subranges are also useful in carrying out the present invention.

What is claimed is:

1. A fabric dryer sheet comprising a flexible substrate and an insecticidally effective amount of an insecticide, the flexible substrate containing between about 0.05 and about 10 grams per square foot of the insecticide.

2. The fabric dryer sheet set forth in claim 1 wherein the insecticide comprises a pyrethrum.

3. The fabric dryer sheet set forth in claim 1 wherein the insecticide comprises a diatomaceous earth.

4. The fabric dryer sheet set forth in claim 2 wherein the pyrethrum is selected from the group consisting of acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof.

5. The fabric dryer sheet set forth in claim 1 wherein the flexible substrate further contains at least one further additive selected from the group consisting of perfumes, fabric softeners, starches and anti-static agents.

6. The fabric dryer sheet set forth in claim 1 wherein the flexible substrate further contains an insect growth regulator.

7. A rinse added fabric treating composition comprising a solution comprising an insecticidally effective amount of an insecticide, the solution comprising from about 0.5 to about 10 percent by weight of the insecticide.

8. The rinse added fabric treating composition set forth in claim 7 wherein the insecticide comprises a pyrethrum.

9. The rinse added fabric treating composition set forth in claim 7 wherein the insecticide comprises a diatomaceous earth.

10. The rinse added fabric treating composition as set forth in claim 8 wherein the pyrethrum is selected from the group consisting of acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, and mixtures thereof.

11. The rinse added fabric treating composition as set forth in claim 7 wherein the solution further comprises at least one further additive selected from the group consisting of perfumes, fabric softeners, starches and anti-static agents.

12. The rinse added fabric treating composition as set forth in claim 7 wherein the solution further comprises an insect growth regulator.
